(19) United States
(12) Patent Application Publication
(10) Pub. No.: US 2015/0339471 A1
(43) Pub. Date: Nov. 26, 2015

(54) DEVICE UNLOCK WITH THREE DIMENSIONAL (3D) CAPTURES

(71) Applicant: TEXAS INSTRUMENTS INCORPORATED, Dallas, TX (US)

(72) Inventors: Terrell BENNETT, Plano, TX (US); Jesse RICHUSO, Dallas, TX (US)

(21) Appl. No.: 14/285,902

(22) Filed: May 23, 2014

(51) Int. Cl. G06F 21/32; H04N 13/02

(52) U.S. Cl. CPC G06F 21/32; H04N 13/0203; H04N 13/0246

(57) ABSTRACT

A method for unlocking a device, comprising projecting, via a light signal projection unit, a plurality of light signals sequentially on a three dimensional (3D) target object, capturing, via an image capture unit, a plurality of images of the target object dynamically, wherein the plurality of images correspond to the sequence of light signals, constructing a 3D feature representation of the target object from the plurality of images, computing a matching score by comparing the constructed 3D feature representation to a reference 3D data set associated with an object that is approved for unlocking the device, and determining to unlock the device when the computed matching score exceeds a pre-determined threshold.

### CROSS-REFERENCE TO RELATED APPLICATION

None.

### BACKGROUND

In recent years, personal portable electronic devices, such as mobile devices, smartphones, and/or personal digital assistants (PDAs) may have become diverse and multi-functional and may be equipped with Internet access, a digital camera, and/or a projector. Users may store personal data (e.g. personal contacts, photos, and/or videos) on the devices and may perform a wide variety of functions (e.g. online banking and/or online purchase via the Internet) with the devices. Many personal portable electronic devices may be lost or stolen each year and the attackers may access personal data and/or other functions on the devices. As such, there may be an increasing importance to secure access (e.g. with secure unlock) to the personal portable electronic devices. Many devices may require a user to enter a password once (e.g. personal identification numbers (PINs)), and storing the password on the device for subsequent authentication and/or authorization. Some devices may attempt to increase security by employing other forms of personal identifications, which may include pattern based identifications, image based identifications, and/or biometric based identifications. However, many of the personal identification mechanisms may be susceptible to intelligent and/or brute force attacks.

### SUMMARY

A secure device unlock scheme with three dimensional (3D) captures is disclosed herein. In one embodiment, a method for unlocking a device including projection a plurality of light signals sequentially on a 3D target object and capturing a plurality of images of the target object dynamically, wherein the plurality of images correspond to the sequence of light signals. The method further includes computing a matching score by comparing the constructed 3D feature representation to a reference 3D data set associated with an object that is approved for unlocking the device. The method further includes determining to unlock the device when the computed matching score exceeds a pre-determined threshold.

In another embodiment, an apparatus includes a storage device to include a reference 3D data set associated with a 3D object that is approved for unlocking the apparatus. The apparatus further includes a light signal projection unit configured to project a sequence of light signals on a 3D target object and an image capture unit configured to capture a plurality of images of the target object dynamically, wherein the plurality of images correspond to the sequence of light signals. The apparatus further includes a processing resource coupled to the storage device, the light signal projection unit, and the image capture unit. The processing resource is configured to compute a 3D feature estimate of the target object from the captured images, wherein the 3D feature estimate comprises a depth value. The processor is further configured to compute a matching score by comparing the 3D feature estimate of the target object to the reference 3D data set and unlock a component of the apparatus when the matching score exceeds a pre-determined threshold.

In yet another embodiment, a mobile device includes a storage device to include a reference 3D point cloud associated with a 3D object that is approved for unlocking the device. The mobile device further includes a digital light processing (DLP) projector configured to project a plurality of light signals sequentially on a 3D target object upon a trigger signal, wherein the light signals comprise structured light patterns. The mobile device further includes a camera configured to capture a plurality of images of the target object synchronized to the structured light patterns. The mobile device further includes a processing resource coupled to the user interface, the memory, the DLP projector, and the camera. The processor is configured to receive an unlock request via the user interface, in response to the unlock request, send the trigger signal to the DLP projector, compute a 3D point cloud from the captured images, compute a matching score by comparing the computed 3D point cloud against the reference 3D point cloud, and unlock the device when the matching score exceeds a pre-determined threshold.

### BRIEF DESCRIPTION OF THE DRAWINGS

For a detailed description of exemplary embodiments of the invention, reference will now be made to the accompanying drawings in which:

FIG. 1 shows a block diagram of a device unlock system set up in accordance with various embodiments;

FIG. 2 shows a block diagram of an electronic device in accordance with various embodiments;

FIG. 3 shows a flowchart of a device unlock method in accordance with various embodiments;

FIG. 4 shows a flowchart of a 3D point cloud generation method in accordance with various embodiments.

FIG. 5A illustrates an embodiment of a 3D image; and

FIG. 5B illustrates an embodiment of a two dimensional (2D) image for a 3D object.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Many personal portable electronic devices (e.g. mobile phones, smartphones, PDAs, etc.) may provide secure device access by implementing secure unlock mechanisms. For example, an owner of a personal portable electronic device may initially configure and store a security profile on the device by providing a personal identification. While the device is in a locked state, the device may only grant access to a user who presents an identification that matches the security profile on the device. Personal identifications may be in multiple forms. Knowledge based identifications, such as user passwords may be commonly employed by many devices for user authentications and/or authorizations. Some devices may employ biometric measures for user authentications and/or authorization, such as facial images, gestures, and/or other biometric scans. Thus, devices may employ various authentications and/or authorizations schemes for unlock depending on the form of personal identifications. For example, a password (e.g. PIN code) protected device may compare a PIN code entered by a user to a PIN code stored in the security profile of the device. An image protected device may capture and/or analyze one or more images of a user (e.g. facial features, finger prints, iris pattern, etc.) in real time and may compare the captured images to images stored in the security profile of the device. A gesture protected device may capture (e.g. frames of images) and/or analyze a sequence of movements acted by a user in real time and may compare the captured gestures to a sequence of images stored in the security profile of the device. However, some attackers may attempt to gain illegitimate access to image based protected devices by presenting copies of the legitimate (e.g. approved) image or similar images.

Recent advancements in Integrated Circuits (ICs) technology, Micro-Electro-Mechanical Systems (MEMs) technology, and/or DLP technology may enable compact (e.g. form factor) and power efficient digital cameras and/or light projectors to be embedded in personal portable electronic devices and/or as add-on accessories to the personal portable electronic devices. The availability of personal portable electronic devices equipped with cameras and/or light projectors may allow the devices to leverage and/or employ 3D imaging techniques for user authentication and/or authorization, which may be less susceptible to spoofing attacks than 2D images, and thus may further improve security.

Embodiments of the device unlock mechanisms disclosed herein include light projections, image captures, 3D images analysis, and 3D data comparison. A user may present a 3D object as a form of user identification for device unlock. The 3D object may be a biometric object (e.g. face, hands, or other body parts) or any other personal object (e.g. a ring) that is uniquely owned by the user. In an embodiment, a device may employ a light projector to project a sequence of light signals (e.g. structured light) on a 3D object presented by a user requesting access to the device and may employ a camera to capture a sequence of 2D images of the 3D object in synchronization with the sequence of projected light signals. Subsequently, the device may analyze the captured images and construct 3D feature estimates from the captured 2D images. The device may compare the constructed 3D feature estimates against a reference 3D data set (e.g. the expected data) pre-configured (e.g. approved personal identifications) and stored in a security profile on the device. In an embodiment, computation of 3D feature estimates may include generating a 3D point cloud (e.g. with x-y-z coordinates) and constructing 3D representations (e.g. depth) of the 3D object from the generated 3D point cloud. In an embodiment, 3D features estimates may be compared by employing standard 2D image recognition, facial recognition, and/or pattern matching techniques, which may include feature extraction (e.g. eyes, nose, cheeks), spacing comparison (e.g. positions), statistical analysis (e.g. principal component analysis, linear discriminant analysis, cross-correlation), and/or other image processing techniques (e.g. edge detection, blob detection, or spot detection).

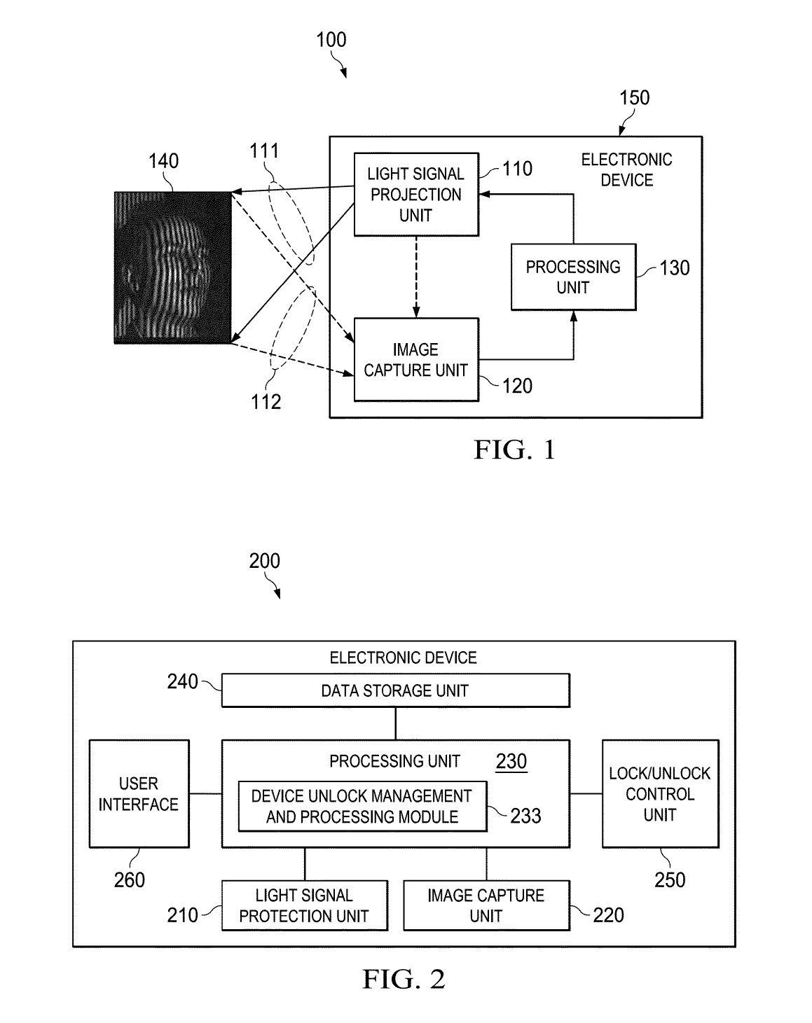

FIG. 1 shows a block diagram of a device unlock system set up 100 in accordance with various embodiments. The device unlock system set up 100 may comprise an electronic device 150 and a 3D object, for example, presented by a user requesting to unlock the electronic device 150. The object 140 may be a user's face as shown in FIG. 1, other body parts (e.g. hands), a personal object that may be uniquely owned by a user (e.g. a ring), or any other suitable object as determined by a person of ordinary skill in the art. Electronic device 150 may be a mobile phone, a smartphone, or any personal electronic device that comprises a light signal projection unit 110, an image capture unit 120, and a processing unit 130. The processing unit 130 may be communicatively coupled to the light signal projection unit 110 and the image capture unit 120. It should be noted that the light signal projection unit 110 and/or the image capture unit 120 may also be add-on accessories to the electronic device 150.

The light signal projection unit 110 may be any device configured to project light signals 111 onto the surface of an object 140. For example, the light signal projection unit 110 may be a DLP projector, a Liquid Crystal on Silicon (LCoS) projector, an infrared (IR) emitter, a laser scanner, and/or any other suitable light projection device as would be appreciated by one of ordinary skill in the art. The light signals 111 may be visible light signals or invisible light signals. Visible light signals may be electromagnetic radiations (e.g. wavelengths from about 390 nanometer (nm) to about 700 nm) that are visible to the human eye. Invisible light signals may be electromagnetic radiations that are invisible to the human eye, for example, infrared light signals (e.g. wavelengths from about 700 nm to about one millimeter (mm)). When a light signal 111 is projected onto an object 140, the light signal 111 may be reflected when the light signal 111 strikes the surface of the object 140. The reflected light signal 112 may vary according to the shape, the surface, and/or the depth of the object 140.

In an embodiment, the light signals 111 may be structured light signals, where each light signal 111 may comprise a digitally encoded pattern. In FIG. 1, the projected light signal 111 may comprise a pattern with alternating vertical bright (e.g. illuminated) and dark (e.g. non-illuminated) stripes. As can be observed in FIG. 1, the reflection of the light pattern (e.g. at the illuminated portions) on the surface of the object 140 is deformed (e.g. by the shape, contour, and/or depth of the object 140). As such, the deformation of the pattern may provide surface profile information of the object 140. When a sequence of light signals 111 comprising different light patterns (e.g. specially designed) are projected onto the object 140, the reflections and/or deformation of each of light signals may be captured (e.g. via an image capture unit 120), analyzed, and correlated with the projected light patterns to extract and/or reconstruct 3D features (e.g. depth) of the object 140.

In an embodiment, a digital pattern generator may be employed to generate digital patterns suitable for structured light projections. The design of the light patterns may depend on several factors, such as spatial resolution requirements, characteristics of the object to be measured, robustness of 3D modeling scheme, decoding strategy for the 3D model, etc. The goal of the design may be to allow a unique code to be generated for each illuminated pixel when captured by the image capture unit 120. Some examples of digital patterns suitable for structured light projection may include binary coded patterns (e.g. with one dimensional (1D) lines or 2D grids), grayscale coded patterns, color coded patterns, sinusoidal phase shifted patterns, pseudorandom coded patterns, etc.

In an embodiment, the light signal projection unit 110 may be a DLP projector. In DLP projectors, images may be created by microscopically small mirrors deposited on a semiconductor chip, which may be known as a Digital Micro-mirror Device (DMD). Each mirror may represent one or more pixels in the projected image. The number of mirrors may correspond to the resolution of the projected image. The mirrors may be toggled at a high speed to create a one or a zero which may correspond to the brightness (e.g. light intensity) of the projected image. A DLP projector may be suitable for structured light projection. For example, a digital pattern generator may generate a sequence of digital patterns and the DLP projector may project the digital patterns as light patterns onto an object 140 accordingly.

When the light signal projection unit 110 is an infrared (IR) emitter, the light signal projection unit 110 may project light signals 111 that are invisible light signals (e.g. electromagnetic radiations with longer wavelengths than the visible light signals). An IR emitter may comprise one or more IR emitting sources and may project structured light signals 111 with various digital patterns onto an object 140.

The image capture unit 120 may be any device configured to capture images (e.g. reflected light signals 112) of an object 140 with substantially high resolution and/or capturing speed. For example, the resolution may depend on the size of the object 140 and/or the minimum 3D feature of the object 140 that may be employed for 3D feature comparisons on electronic device 150 for device unlock. Since a sequence of images may be captured for each unlock request, the capturing speed of the image capture unit 120 may determine how fast the electronic device 150 may be unlocked. In addition, a high capturing speed may provide more consistent and/or accurate 3D feature estimates since the 3D feature estimates are computed by correlating the entire sequence of light signals and captured images.

The types of image capture unit 120 may vary depending on the types of employed light signal projection unit 110. For example, the image capture unit 120 may be a camera (e.g. 2D camera) when the light signal projection unit 110 is a DLP projector. Alternatively, the image capture unit 120 may include one or more IR sensors, an IR camera, and/or a camera with add-on IR filters when the light signal projection unit 110 is an IR emitter. The image capture unit 120 may also be a stereo camera, a time of flight sensor, and/or any other suitable image capture device as would be appreciated by one of ordinary skill in the art. It should be noted that the image capture unit 120 and the light signal projection unit 110 may be positioned and/or configured to share the same field of view such that the image capture unit 120 may capture images of surface areas of the object 140 that are illuminated by the light signals 111.

The processing unit 130 may comprise processing resources configured to control, manage, and/or synchronize the light signal projection unit 110 and the image capture unit 120. The processing unit 130 may be responsible for sequencing the digital patterns for light projection, determining the time instants when the light signal projection unit 110 may project a light signal 111 on the object 140 and when the image capture unit 120 may capture an image of the object 140 (e.g. one image per light pattern). The processing unit 130 may be further configured to reconstruct one or more 3D models (e.g. via 3D point cloud generation) from the captured images (e.g. standard 2D images, stereoscopic images, time of flight images, etc.). The processing unit 130 may perform 3D image analysis and comparison to determine whether to grant or deny a user access request according to the 3D image analysis and comparison result.

In an embodiment, the electronic device 150 may comprise a security profile, which may be configured by a user once during initial device set up and may be updated subsequently. A user may select a reference 3D object (e.g. approved object) as a form of personal identification for the electronic device 150. The reference 3D object may be a biometric object (e.g. a user's face) or any other 3D object (e.g. a ring) uniquely owned by the user. A device security profile configuration process may include capturing a plurality of images of the reference 3D object via the image capture unit 120, generating a reference 3D data set from the captured images, and storing the reference 3D data set on the device. For example, the image capture unit 120 may capture images of the reference 3D object from different angles and/or with structured light comprising different light patterns. In addition, the device security profile configuration process may include calibration of the light signal projection unit 110 and/or the image capture unit 120 to improve system accuracy, where calibration may include internal system parameters of the light signal projection unit 110 and/or the image capture unit 120, or other external parameters associated with the 3D object and/or environment.

A user may request to unlock electronic device 150 by presenting an object 140 as a user identification, for example, by pointing the image capture unit 120 and the light signal projection unit 110 of electronic device 150 towards the object 140 and indicating an unlock request to the electronic device 150 (e.g. via a user interface). Upon receiving the user unlock request, the processing unit 130 may determine a sequence of digital patterns (e.g. binary coded, gray scale coded, pseudo random coded, etc.) for structured light projection, where the sequence of digital patterns may be a pre-determined sequence or may be generated dynamically. The processing unit 130 may communicate the digital patterns to the light signal projection unit 110 and may instruct the light signal projection unit 110 to project light signals 111 onto the object 140 accordingly. The processing unit 130 may control and/or instruct the image capture unit 120 to capture an image of the object 140 for each projected light pattern. For example, the processing unit 130 may synchronously coordinate the light signal projection unit 110 and the image capture unit 120, such that the capture unit 120 may capture images at time instants when the light signal projection unit 110 is projecting a steady light signal pattern on the object 140 and not during transitions of light patterns. Alternatively, the light signal projection unit 110 may be further configured to communicatively couple to the image capture unit 120 and trigger the image capture unit 120 to capture images synchronously with the light projections.

After projecting the sequence of light signals and capturing images of the object 140 for each projected light pattern, the processing unit 130 may process the captured images and compute 3D feature estimates from the captured images. For example, a 3D point cloud may be generated from the captured images and the depths at each point (e.g. image pixel) of the 3D object 140 may be computed. The processing unit 130 may compare the computed 3D feature estimates to the pre-stored reference 3D data set to determine whether the object 140 (e.g. presented by the user who is requesting to unlock the device) is associated with the reference 3D object.

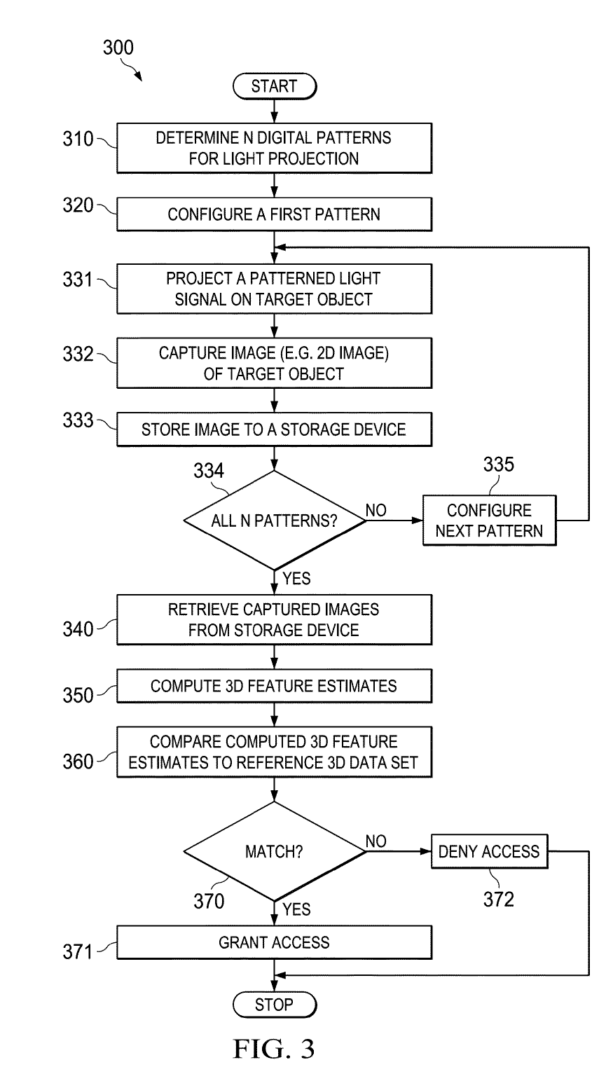

FIG. 2 shows a block diagram of an electronic device 200 in accordance with various embodiments. Device 200 may act as a personal portable electronic device (e.g. mobile phones, smartphone, PDAs, etc.), which may be substantially similar to electronic device 150. Device 200 is included for purposes of clarity of discussion, but is in no way meant to limit the application of the present disclosure to a particular electronic device embodiment. At least some of the features/methods described in the disclosure may be implemented in the device 200. For instance, the features/methods in the disclosure may be implemented using hardware, firmware, and/or software installed to run on hardware. As shown in FIG. 2, device 200 may comprise a processing unit 230 coupled to a light signal projection unit 210 and an image capture unit 220, where the processing unit 230, the light signal projection unit 210, and the image capture unit 220 may be substantially similar to processing unit 130, light signal projection unit 110, and image capture unit 120, respectively. The processing unit 230 may comprise computing resources, such as one or more general purpose processors and/or multi-core processors. The processing unit 230 may be coupled to a data storage unit 240. The processing unit 230 may comprise a device unlock management and processing module 233 stored in internal non-transitory memory in the processing unit 230 to permit the processing unit 230 to implement device unlock method 300 and/or 3D point cloud generation method 400, discussed more fully below. In an alternative embodiment, the device unlock management and processing module 233 may be implemented as instructions stored in the data storage unit 240, which may be executed by the processing unit 230. The data storage unit 240 may comprise a cache for temporarily storing content, for example, a random access memory (RAM). Additionally, the data storage unit 240 may comprise a long-term non-volatile storage for storing content relatively longer, for example, a read only memory (ROM). For instance, the cache and the long-term storage may include dynamic random access memories (DRAMs), solid-state drives (SSDs), hard disks, optical storage devices, flashes, or combinations thereof.

Device 200 may further comprise a user interface 260 and a device lock control unit 250 coupled to the processing unit 230. The user interface 260 may be configured to receive users' inputs (e.g. via touch screen, push buttons, switches) and may request the processing unit 230 to act on the users' inputs. The device lock control unit 250 may be configured to lock and/or unlock the device 250 mechanically and/or electronically. For example, the device lock control unit 250 may be triggered to lock the device 200 upon a user lock request received from the user interface 260 or a timeout after certain period of inactivity. Conversely, the device control unit 250 may be triggered to unlock the device 200 upon an unlock instruction received from the processing unit 230 upon a successful user authentication and/or authorization.

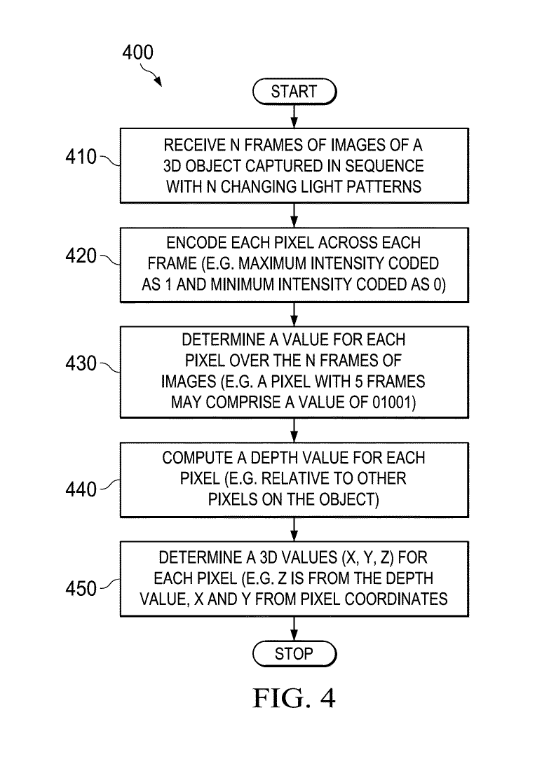

FIG. 3 shows a flowchart of a device secured unlock method 300 in accordance with various embodiments. Method 300 may be implemented on a personal portable electronic device, such as electronic device 150 and/or 200. Method 300 may be performed with a system set up substantially similar to device unlock system set up 100. Method 300 may begin when a user presents a 3D object (e.g. object 140) as user identification for device unlock. At step 310, method 300 may determine a number of digital patterns for light projections, where the number of digital patterns may be N. Some examples of digital patterns may include binary coded patterns, grayscale coded patterns, color coded patterns, sinusoidal phase shifted patterns, pseudorandom coded patterns, or any other digitally coded patterns suitable for structured light projection as determined by a person of ordinary skill in the art. At step 320, method 300 may configure a first digital pattern for light projection.

At step 331, method 300 may project a light signal (e.g. light signal 111) comprising the configured digital pattern via a light signal projection unit (e.g. light signal projection unit 110 or 210) on the surface of the 3D object. At step 332, method 300 may capture an image (e.g. 2D image) of the 3D object via an image capture unit (e.g. image capture unit 120 or 220) while the light signal is projected onto the surface of the 3D object. The captured image may comprise an illumination pattern corresponding to the digital pattern. The brightness (e.g. intensity) and the displacement (e.g. deformity) of each illuminated pixel may vary depending on the object's surface, shape, etc. At step 333, after capturing the image, method 300 may store the captured image on a data storage device (e.g. data storage device 240). At step 334, method 300 may determine whether all the N patterns have been employed for light projection. If there are remaining patterns, method 300 may proceed to step 335 to configure a next digital pattern and may repeat the loop of steps 331 to 334. Otherwise, method 300 may proceed to step 340.

At step 340, method 300 may retrieve the captured images from the storage device. At step 350, method 300 may compute 3D features estimates from the captured images, where each captured image may correspond to one of the N light projection patterns. Some examples of 3D feature estimation techniques may include 3D point cloud generations and/or depth value computations. At step 360, method 300 may compare the computed 3D feature estimates against a reference 3D data set, for example, by computing a matching score. The reference 3D data set may be pre-generated from captures of an approved object and stored on the device. At step 370, method 300 may determine whether the computed 3D features estimates match (e.g. exceeds a pre-determined threshold) the reference 3D data set. If the computed 3D feature estimates match the reference 3D data set, method 300 may proceed to step 371. At step 371, method 300 may grant the user access by unlocking the device. If the computed 3D feature estimates fail to match the reference 3D data set, method 300 may proceed to step 372. At step 372, method 300 may deny the user access. It should be noted that method 300 may also be suitable for gestures based identification. In an embodiment, the 3D object may be a user's face and the gestures may include a user opening and/or closing the user's mouth or a sequence of other movements. In such an embodiment, the projecting of light signals and capturing of images in steps 331 to 334 may be repeated for each movement. In addition, method 300 may compute 3D feature estimates by generating one or more 3D point clouds and/or other 3D features at step 350 and may compare each generated 3D point cloud to a corresponding 3D reference data set. For example, method 300 may generate one score for each movement and/or some weighted score for the sequence of movements.

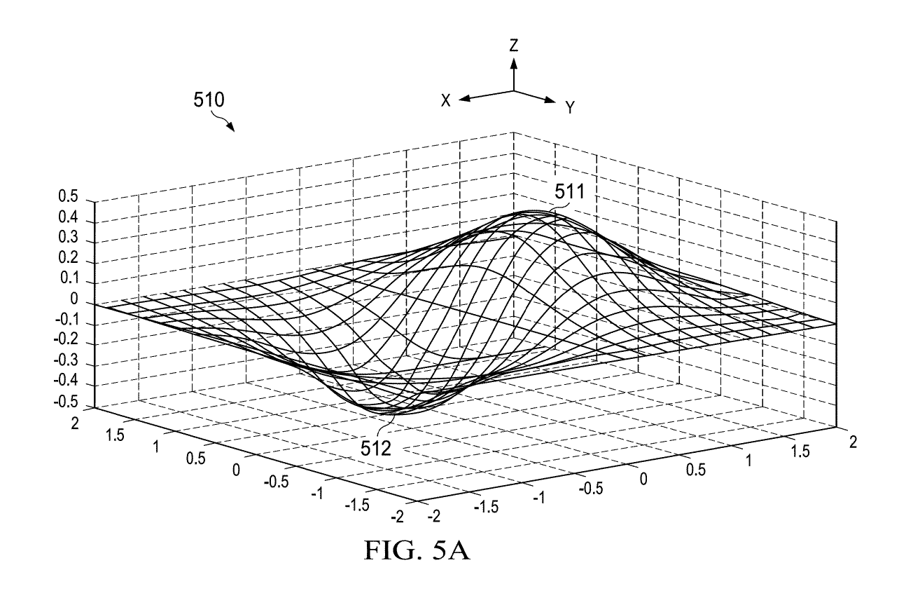

FIG. 4 shows a flowchart of a 3D point cloud generation method 400 in accordance with various embodiments. Method 400 may be implemented on a personal portable electronic device, such as electronic device 150 and/or 200. Method 400 may begin with receiving N frames of images of a 3D object (e.g. object 140) captured in sequence with N changing light patterns as shown in step 410. The N frames of images may be captured by employing substantially similar mechanisms as in steps 310 to 334 of method 300 described herein above. At step 420, method 400 may encode each pixel across each frame of images. For example, method 400 may encode a pixel maximum intensity pixel (e.g. illuminated pixel) to a value of one and a minimum intensity pixel (e.g. non-illuminated intensity) to a value of zero. It should be noted that the illuminated pixels may be displaced (e.g. deformed) when compared to the projected light pattern since the projected light may vary differently for each pixel depending on the shape and/or the surface of the object.

After encoding pixels for each frame, at step 430, method 400 may determine a value for each pixel over the N frames of images. For example, a pixel across five frames may comprise a binary value of 01001 when the pixel is coded as a 0, 1, 0, 0, and 1 for the first, second, third, fourth, and fifth frame, respectively. At step 440, method 400 may determine a depth value for each pixel relative to other pixels on the object based on the pixel values computed at step 430. At step 450, method 400 may construct a 3D representation of the object by generating a 3D x-y-z coordinates for each pixel on the object. For example, the x and y coordinates may correspond to the pixel coordinates (e.g. from the 2D images) and the z coordinate may correspond to the depth value determined at step 440.

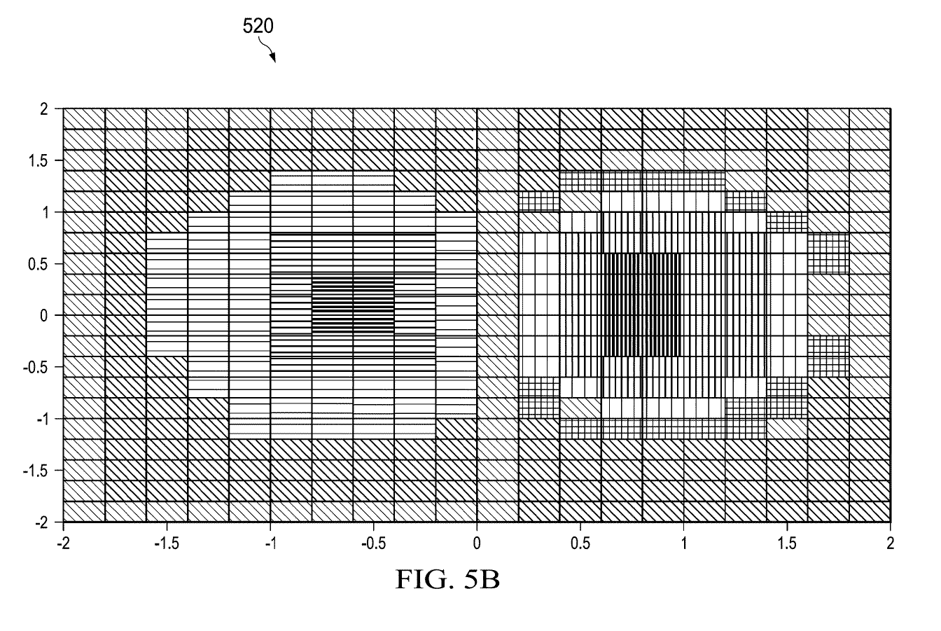

FIG. 5A illustrates an embodiment of a 3D image 510 in a 3D x-y-z coordinate system. For example, the 3D image may be a 3D point cloud generated from substantially similar mechanisms as method 400 described herein above. The 3D image 510 may comprise a protruded region 511 and a recessed region 512. The 3D image 510 may be treated as a continuous surface. In other words, the 3D image 510 may be represented as a 2D image with a depth value for every pixel. As such, a 3D image may be stored as a 2D image with pixel intensity (e.g. brightness) or pixel color based on the depth of the pixel. FIG. 5B illustrates an embodiment of a 2D image 520 that represents the 3D image 510. In image 520, each pixel may be represented by an x-y coordinate value (e.g. in a horizontal x-axis and a vertical y-axis) and a depth value, where the depth of the pixel may be represented by a plurality of colors (e.g. an eight-bit depth value may be represented by 256 colors). For example, in image 520, the pixels corresponding to the recessed region 512 (e.g. between about 0 and about −1.5 in the x-axis and between about −1.2 and about 1.2 in the y-axis in image 520) may be represented by various shades of blue, where a darker shade may correspond to a deeper recession (e.g. progressively darker shades towards about the middle of the recessed region 512). Similarly, the pixels corresponding to the protruded region 511 (e.g. between about 0.25 and about 1.75 in the x-axis and between about −1.2 and about 1.2 in the y-axis in image 520) may be represented by various shades of red, where a darker shade may correspond to a higher protrusion (e.g. progressively darker shades towards about the middle of the protruded region 511). It should be noted that pixel intensities or pixel colors may also be employed for representing other 3D features of an object. In addition, 3D image data may be stored in other suitable format as would be appreciated by one of ordinary skill in the art.

In an embodiment, 3D images may be converted into 2D representations. As such, 3D data matching and/or comparison may leverage and/or employ 2D imaging and/or facial recognition techniques and/or 2D pattern matching techniques. For example, some facial recognition techniques may include extracting facial features and analyzing the relative position, size, shape, and/or contour of the eyes, nose, cheekbones, and/or jaw. In addition, 3D data matching and/or comparison may include statistical analysis techniques, such as principal component analysis, linear discriminant analysis, and/or cross correlation. Principal component analysis may convert a set of possible correlated observations and/or variables into a reduced set of uncorrelated variables (e.g. principal components). Linear discriminant analysis may determine a linear combination of features which may characterize or separate two or more classes of objects and may provide dimensionality reduction (e.g. for classifications). Cross-correlation may provide a measure of similarities between two patterns. 3D data matching and/or comparison may further include image processing techniques, such as edge detection, blob detection, and/or spot detection. It should be noted that 3D data matching may include other suitable 2D and/or 3D imaging techniques as would be appreciated by one of ordinary skill in the art.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method for unlocking a device, comprising:
projecting, via a light signal projection unit, a plurality of light signals sequentially on a three dimensional (3D) target object;
capturing, via an image capture unit, a plurality of images of the target object dynamically, wherein the plurality of images correspond to the sequence of light signals;
constructing a 3D feature representation of the target object from the plurality of images;
computing a matching score by comparing the constructed 3D feature representation to a reference 3D data set; and
determining to unlock the device when the computed matching score exceeds a pre-determined threshold.

2. The method of claim 1 further comprising synchronizing the image capture unit to the light signal projection unit such that one image is captured for each light signal.

3. The method of claim 1 further comprising situating the light signal projection unit and the image capture unit such that the light signal projection unit and the image capture unit comprises a shared field of view directing towards the 3D target object.

4. The method of claim 1, wherein the light signals are structured light signals, and wherein each light signal comprises a different digitally encoded pattern.

5. The method of claim 4 further comprising storing each captured image after each capture, wherein constructing the 3D feature representation comprises generating a 3D point cloud according to each image and each digitally encoded pattern.

6. The method of claim 1, wherein the light signals comprise electromagnetic radiations in a spectrum visible to a human eye.

7. The method of claim 1, wherein the light signals comprise electromagnetic radiations in a spectrum invisible to a human eye.

8. The method of claim 1 further comprising:
calibrating the light signal projection unit;
calibrating the camera capture unit; and
generating the reference 3D data set, wherein generating the reference 3D data set comprises capturing images of the approved object in one or more angles.

9. The method of claim 1, wherein the target object comprises a user's body part, a user's object, or combinations thereof.

10. The method of claim 1, wherein the images comprise captures of the target object in a still position.

11. The method of claim 1, wherein the images comprise captures of one or more pre-determined movements of at least one portion of the object.

12. An apparatus, comprising:
a storage device to include a reference three dimensional (3D) data set;
a light signal projection unit configured to project a sequence of light signals on a 3D target object;
an image capture unit configured to capture a plurality of images of the target object dynamically, wherein the plurality of images correspond to the sequence of light signals; and
a processing resource coupled to the storage device, the light signal projection unit, and the image capture unit and configured to:
compute a 3D feature estimate of the target object from the captured images, wherein the 3D feature estimate comprises a depth value;
compute a matching score by comparing the 3D feature estimate of the target object to the reference 3D data set; and
unlock a component of the apparatus when the matching score exceeds a pre-determined threshold.

13. The apparatus of claim 12, wherein the sequence of light signals are structured light signals comprising a binary coded pattern, a grayscale coded pattern, a color coded pattern, a sinusoidal phase shifted pattern, a pseudorandom coded pattern, or combinations thereof.

14. The apparatus of claim 12, wherein the target object comprises a user's body part, a user's object, or combinations thereof, and wherein the images comprise captures of the target object with at least one portion of the target object in one or more positions.

15. The apparatus of claim 12, wherein the image capture unit and the light signal projection unit are further configured to comprise a shared field of view directing towards the target object, and wherein the image capture unit is further configured to synchronize to the light signal projection unit such that one image is captured for each light signal.

16. The apparatus of claim 12, wherein the image capture unit is further configured to store the plurality of images on the storage device after capturing each image, and wherein computing the 3D feature estimate comprises:
retrieving the captured images from the storage device; and
generating a 3D point cloud from the retrieved images.

17. The apparatus of claim 12, wherein the light signal projection unit is a digital light processing (DLP) projector, and wherein the image capture unit is a camera.

18. A mobile device, comprising:
a user interface;
a storage device to include a reference three dimensional (3D) point cloud;
a digital light processing (DLP) projector configured to project a plurality of light signals sequentially on a 3D target object upon a trigger signal, wherein the light signals comprise structured light patterns;
a camera configured to capture a plurality of images of the target object synchronized to the structured light patterns, wherein the camera and the DLP comprise a shared field of view directed towards the target object; and
a processing resource coupled to the user interface, the memory, the DLP projector, and the camera, wherein the processor is configured to:
receive a unlock request via the user interface;
in response to the unlock request, send the trigger signal to the DLP projector;
compute a 3D point cloud from the captured images;
compute a matching score by comparing the computed 3D point cloud against the reference 3D point cloud; and
unlock the device when the matching score exceeds a pre-determined threshold.

19. The mobile device of claim 18, wherein the target object comprises a user's body part, a user's object, or combinations thereof, and wherein images comprise captures of the target object in a still position.

20. The mobile device of claim 18, wherein the images comprise captures of one or more pre-determined movements of at least one portion of the target object.
